(19) United States
(12) Patent Application Publication
(10) Pub. No.: US 2009/0049162 A1
(43) Pub. Date: Feb. 19, 2009

(54) BUFFER MANIPULATION

(76) Inventors: Deh-Yung Kuo, Taipei (TW); Inn Nam Yong, Singapore (SG); Kee Chin Teo, Singapore (SG); Xudong Chen, Singapore (SG)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/840,167

(22) Filed: Aug. 16, 2007

(51) Int. Cl. G06F 15/16

(52) U.S. Cl. 709/223

(57) ABSTRACT

A method and system for increasing throughput of incoming data and outgoing data through buffer manipulation is described. A channel connection is provided for determining which buffers are used for reading incoming data. Buffer manipulation includes enabling the reading of a subset of the incoming data directly into an application buffer associated with an application when a first set of criteria is met and enabling the reading of existing data from an intermediate buffer and storing the subset of the incoming data in the intermediate buffer when a second set of criteria is met.

### TECHNICAL FIELD

The disclosed embodiments relate generally to peer-to-peer communications in computer networks, and more specifically to aspects of increasing throughput of incoming data and outgoing data.

### BACKGROUND

Currently, communications between a pair of peer-to-peer computers on a network require multiple open ports corresponding to the multiple data streams that are communicated between the given pair of peer-to-peer computers. Further, data throughput may be inefficient due to memory copy between components.

### BRIEF DESCRIPTION OF THE DRAWINGS

FIG. 1 is a block diagram illustrating an exemplary distributed computer system, according to certain embodiments of the invention.

FIG. 2 is a block diagram illustrating exemplary peer computers, according to certain embodiments of the invention.

FIGS. 3A, 3B and 3C are block diagrams illustrating a buffer in a respective channel connection, according to certain embodiments of the invention.

FIG. 4 is a block diagram illustrating the buffer of FIG. 3 when the buffer is read, according to certain embodiments.

FIG. 5 is a high-level flowchart illustrating a method of buffer manipulation for increasing throughput, according to certain embodiments.

### DESCRIPTION OF EMBODIMENTS

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments of the invention, when a first peer computer receives incoming data from a second peer computer, the incoming data is read directly into an application buffer that is associated with an application when a first set of criteria is met. If a second set of criteria is met, data that already exists in an intermediate buffer associated with the first peer computer is first read and the incoming data is stored in the intermediate buffer. According to certain embodiments, the intermediate buffer is a circular buffer and any incoming data that is stored in the intermediate buffer is stored and subsequently read in the order that the data is received at the peer computer.

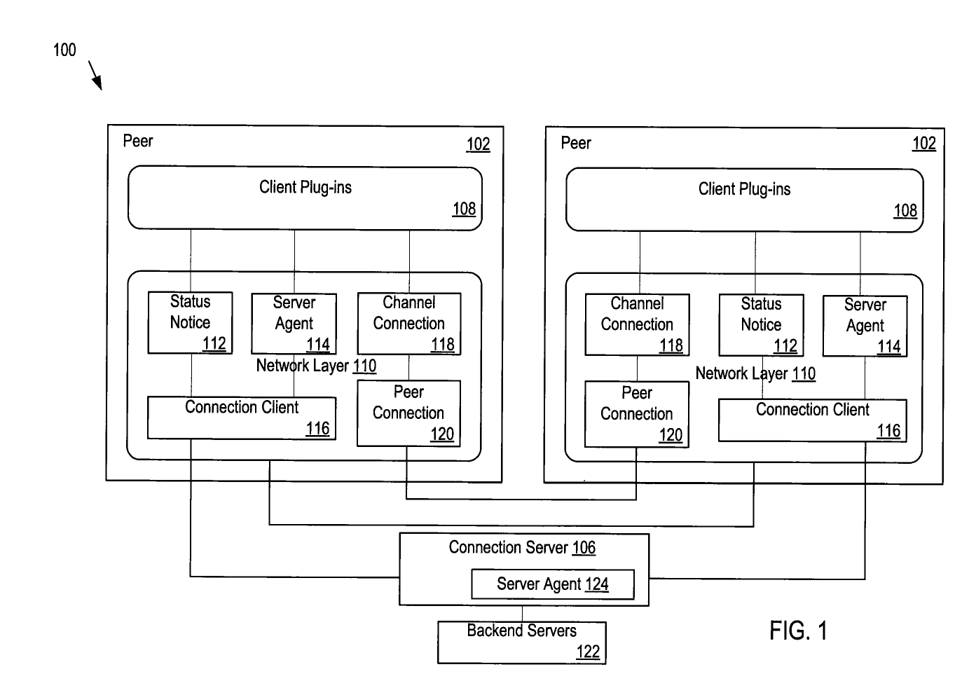

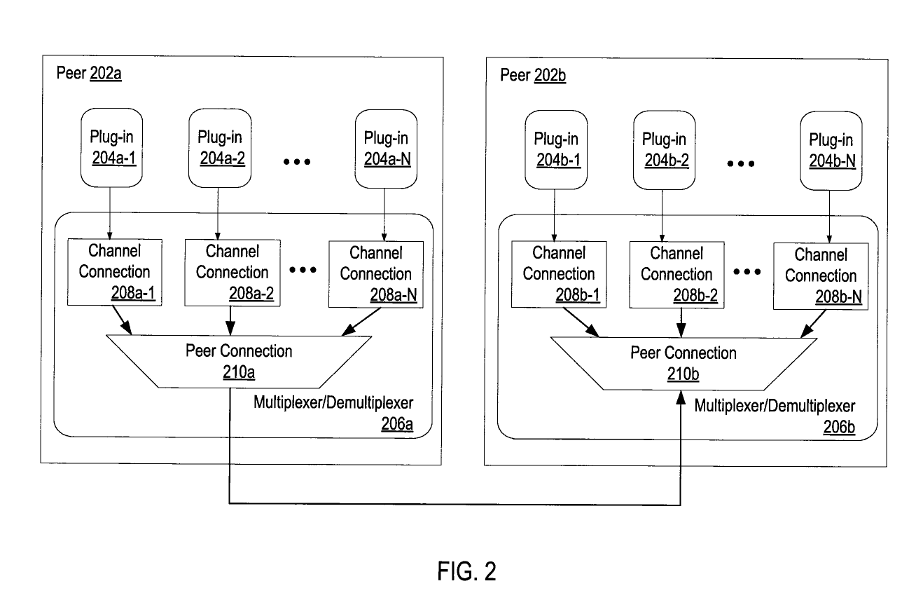

FIG. 1 is a block diagram illustrating an exemplary distributed computer system 100, according to certain embodiments of the invention. In FIG. 1, system 100 may include a plurality of peer computers 102, a connection server 106 and optionally one or more other servers, such as back end servers 122. Connection server 106 may access one or more databases (not shown in FIG. 1). Peer computers 102 can be any of a number of computing devices (e.g., desktop computers, Internet kiosk, personal digital assistant, cell phone, gaming device, laptop computer, handheld computer, or combinations thereof) used to enable the activities described below. According to certain embodiments, peer computer 102 includes a plurality of client plug-ins 108, and a network layer 110. Network layer 110 includes a status/notice component 112, a client-side server agent 114, a connection client 116, and at least one data multiplexer. The data multiplexer includes a plurality of channel connections 118 corresponding to the plurality of plug-ins 108, and at least one peer connection 120. The data multiplexer is described in greater detail herein with reference to FIG. 2.

Connection server 106 may access back end servers 122 to retrieve or store information, for example. Back end servers 122 may include advertisement servers, status servers, accounts servers, database servers, etc. A non-limiting example of information that may be stored in backend servers include the profile and verification information of respective peer computers. According to certain embodiments, status servers broadcast information such as product or company announcements, status information, or information that is specific to certain groups of users.

According to certain embodiments, status/notice component 112 listens for information broadcast by connection server 106. Status/notice component 112 presents the broadcasted data at respective peer computers 102, through a user interface window, for example. Broadcast information may include advertisements from advertisement servers, status information from status servers, service announcements, news, etc. According to certain other embodiments, status/notice component 112 may request such information from connection server 106. In response, connection server 106 requests the information from the relevant backend servers in order to fulfill the request from the status/notice component 112. Upon receipt, the requested information may be displayed through the user interface window.

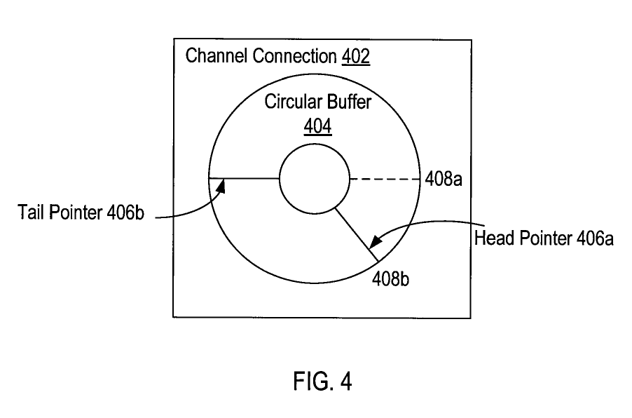

Connection server 106 includes a server agent 124. Peer computers 102 log on to connection server 106 before communicating with other peer computers. Connection server 106 introduces peer computers to one another, as described in greater detail herein with reference to FIG. 4. Peer computer 102 communicates with connection server 106 through client-side server agent 114 and the server-side server agent 124. According to certain embodiments, client side server agent 114 sends requests from peer computer 102 to connection server 106. Server agent 124 forwards such requests to the relevant components or servers.

Peer computers 102 are connected to connection server 106 via a communications network(s). In some embodiments, connection server 106 is a Web server or an instant messenger. Alternatively, if connection server 106 is used within an intranet, it may be an intranet server. In some embodiments, fewer and/or additional modules, functions or databases are included in peer computers 102 and connection server 106. The communications network may be the Internet, but may also be any local area network (LAN), a metropolitan area network, a wide area network (WAN), such as an intranet, an extranet, or the Internet, or any combination of such networks. It is sufficient that the communication network provides communication capability between the peer computers 102 and the connection server 106. The various embodiments of the invention, however, are not limited to the use of any particular protocol.

Notwithstanding the discrete blocks in FIG. 1, the figure is intended to be a functional description of some embodiments of the invention rather than a structural description of functional elements in the embodiments. One of ordinary skill in the art will recognize that an actual implementation might have the functional elements grouped or split among various components. Moreover, one or more of the blocks in FIG. 1 may be implemented on one or more servers designed to provide the described functionality. Although the description herein refers to certain features implemented in peer computer 102 and certain features implemented in connection server 106, the embodiments of the invention are not limited to such distinctions. For example, features described herein as being part of connection server 106 could be implemented in whole or in part in peer computer 102, and vice versa.

FIG. 2 is a block diagram illustrating peer computers, according to certain embodiments of the invention. FIG. 2 shows peer computer 202a in communication with peer computer 202b. Peer computer 202a includes at least one multiplexer/demultiplexer 206a, and a plurality of plug-ins 204a-1, 204a-2, . . . , 204a-N. Non-limiting examples of plug-ins include application-sharing plug-ins, video plug-ins, audio plug-ins, and text chat plug-ins. According to certain embodiments, multiplexer/demultiplexer 206a includes a plurality of channel connections 208a-1, 208a-2, . . . , 208a-N corresponding to the plurality of plug-ins 204a-1, 204a-2, . . . , 204a-N and a peer connection 210a. Similarly, peer computer 202b includes at least one multiplexer/demultiplexer 206b, and a plurality of plug-ins 204b-1, 204b-2, . . . , 204b-N. Multiplexer/demultiplexer 206b includes a plurality of channel connections 208b-1, 208b-2, . . . , 208b-N corresponding to the plurality of plug-ins 204b-1, 204b-2, . . . , 204b-N and a peer connection 210b.

According to certain embodiments, a connection is created between peer computer 202a and 202b through peer connection 210a and 210b, respectively. For purposes of explanation, assume that peer computer 202a would like to pass data corresponding to several service types, such application-sharing, video, audio, etc., contemporaneously to peer computer 202b. The plurality of channel connections (208a-1, 208a-2, . . . , 208a-N) receive data from corresponding plug-ins (204a-1, 204a-2, . . . , 204a-N). Such multiple channel connections of data are merged into one stream when passed to peer connection 210a. The single stream of data is passed to peer connection 210b through a single connection between peer computer 202a and 202b. Peer computer 202b demultiplexes the single stream data received from peer computer 202a into respective channel types of data that is sent into the plurality of channel connections (208b-1, 208b-2, . . . , 208b-N) corresponding to the plurality of service type plug-ins (204b-1, 204b-2, . . . , 204b-N).

According to certain embodiments, the peer connection, such as peer connection 210a of 202a or peer connection 210b of 202b, may be used to connect to multiple peer computers simultaneously for communicating data. According to certain embodiments, the multiplexer/demultiplexer can demultiplex data received from multiple peer computers simultaneously.

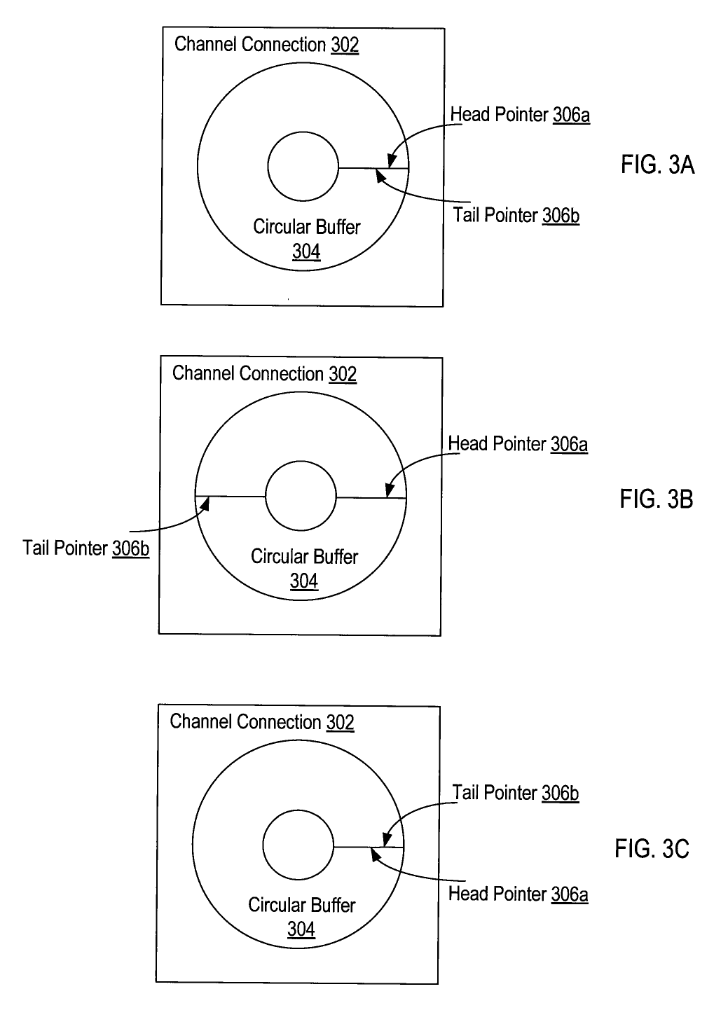

According to certain embodiments, a channel connection, such as channel connections 208a-1, 208a-2, . . . , 208a-N, 208b-1, 208b-2, . . . , 208b-N, is associated with an intermediate buffer. According to certain embodiments, the intermediate buffer is a circular buffer. One embodiment of a circular buffer is described in greater detail herein with reference to FIGS. 3A, 3B and 3C.

FIGS. 3A, 3B and 3C are block diagrams illustrating a buffer in a respective channel connection, according to certain embodiments of the invention.

FIG. 3A shows a circular buffer 304 associated with a channel connection 302. Circular buffer 304 includes a head pointer 306a and a tail pointer 306b. Head pointer 306a and tail pointer 306b are aligned when the circular buffer has no data or is full of data. FIG. 3A shows that the circular buffer is empty. When there is data stored in the circular buffer, the head pointer points to the beginning of the data and the tail pointer points to the end of the data in the circular buffer. Incoming data is appended to the location pointed by the tail pointer. The tail pointer is adjusted to point to the end of the newly appended incoming data.

FIG. 3B shows that circular buffer 304 has some data. Head pointer 306a points to the beginning of the data stored in circular buffer 304. Tail pointer 306b points to the end of the stored data in circular buffer 304. For purposes of explanation, assume that more incoming data is appended to the end location of the existing data until circular buffer 304 is full. FIG. 3C shows that circular buffer 304 is full of data. Tail pointer 306b now aligned with head pointer 306a.

When the channel connection associated with the circular buffer reads data from the circular buffer, the channel connection begins reading the data from the location pointed by the head pointer. When data is read, the head pointer is adjusted to the end of the data that has just been read.

According to certain embodiments, the circular buffer has an initial size that is optimized based on an initial request, at the external interface of a respective channel connection, to obtain buffer memory location. The size of the circular buffer is allowed to expand to a pre-determined size to accommodate circumstances in which the corresponding plug-in is unable to consume data quickly enough and when the plug-in buffer is full.

FIG. 4 is a block diagram illustrating the buffer of FIG. 3 when the buffer is read, according to certain embodiments. FIG. 4 shows a circular buffer 404 associated with a channel connection 402. FIG. 4 also shows a head pointer 406a and a tail pointer 406b. For purposes of explanation, assume that before channel connection 402 reads data from circular buffer 404, head pointer 406a points to location 408a. Tail pointer 406b points to the end location of the data that is stored in circular buffer 404. Further assume that channel connection 402 reads some of the data stored in circular buffer 404. After the data is read, head pointer 406a is adjusted to the location 408b, which is the new start of location of data that has yet to be read by channel connection 402. In other words, when channel connection 402 next reads data from circular buffer 404, the data is read starting at location 408b.

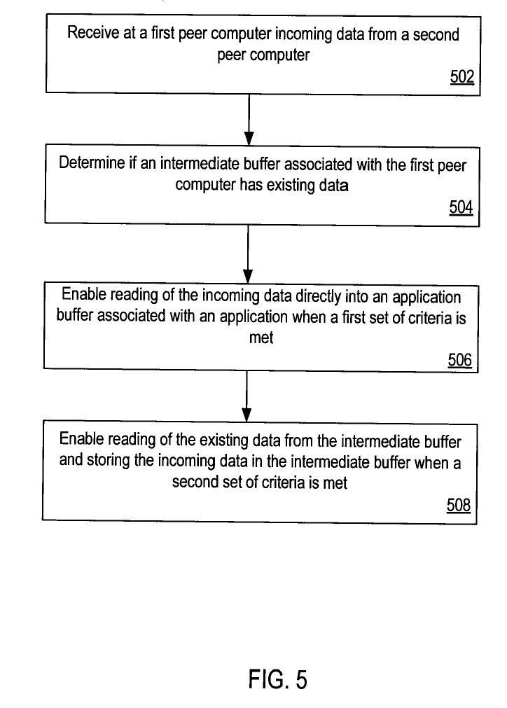

FIG. 5 is a high-level flowchart illustrating a method of buffer manipulation for increasing throughput, according to certain embodiments. A first peer computer receives incoming data from a second peer computer (502). It is determined if an intermediate buffer that is associated with the first peer computer has existing data (504). The incoming data is read directly into an application buffer associated with an application when a first set of criteria is met (506). Existing data from the intermediate buffer is read and the incoming data is stored in the intermediate buffer when a second set of criteria is met (508). According to certain embodiments, the intermediate buffer is a circular buffer and any incoming data that is stored in the intermediate buffer is stored and subsequently read in the order that the data arrives at the first peer computer.

For purposes of explanation, assume that there is incoming data arriving at a first peer computer from a second peer computer. When data arrives at the transport layer at the first peer computer, the peer connection at the first peer computer is notified. Upon notification, the peer connection invokes an interface to the relevant channel connection to obtain the memory location of a relevant buffer.

For example, with reference to FIG. 2, if the incoming data is associated with plug-in 204a-1, then the relevant channel connection is channel connection 208a-1 because channel connection 208a-1 is the channel connection associated with plug-in 204a-1. To continue with the above example, the relevant buffer can be either the buffer of plug-in 204a-1 or the circular buffer associated with channel connection 208a-1. If at the time the data arrives at the transport layer, either plug-in 204a-1 has not provided memory location information of its buffer or the circular buffer associated with channel connection 208a-1 is non-empty, then channel connection 208a-1 provides the memory location of the circular buffer to the peer connection for storing the incoming data in the circular buffer, according to certain embodiments of the invention. After the peer connection stores the incoming data in the circular buffer at the provided memory location, the peer connection informs the channel connection 208a-1 of the size of the data that is stored so that the tail pointer location of the circular buffer can be adjusted to indicate the end location of the newly stored data in the circular buffer.

As another example, assume that a plug-in such as plug-in 204a-1 requests to read data by calling the read interface associated with channel connection 208a-1. Channel connection 208a-1 determines whether there is data stored in the circular buffer associated with channel connection 208a-1. If channel connection 208a-1 determines that the circular buffer is empty, then channel connection 208a-1 provides the memory location of the plug-in buffer to the peer connection so that incoming data, if any, can be directly written to plug-in buffer to avoid a subsequent memory copy. However, if the channel connection 208a-1 determines that the circular buffer is not empty, then data first needs to be read from the circular buffer in a manner that preserves the order in which the data arrived at the peer connection. As long as the circular buffer is not empty at the time data arrives at the peer connection, then the arriving data is written to the circular buffer for storage rather than being written directly to the plug-in buffer, according to certain embodiments of the invention.

According to certain embodiments of the invention, circular buffer allows concurrent read and write access. In other words, when the peer connection is writing data to the circular buffer, and if at the same time, a plug-in requests to read data from the circular buffer, both of these operations can occur concurrently, according to certain embodiments. Such a non-blocking approach allows for multithreaded access to the circular buffer.

According to certain embodiments, when a plug-in at one respective peer computer (originating peer computer) wishes to send data (outgoing data) to another respective peer computer (destination peer computer), the channel connection associated with the respective plug-in of the originating peer computer provides the memory location information of the respective plug-in's buffer to the peer connection at the originating peer computer so that the peer connection can directly access the outgoing data for preparing the transport layer data packet for transmission to the destination peer computer, according to certain embodiments of the invention.

In the foregoing specification, embodiments of the invention have been described with reference to numerous specific details that may vary from implementation to implementation.

We claim:

1. A method comprising:
receiving at a first peer computer incoming data from a second peer computer;
in response to receiving the incoming data, determining if an application buffer or an intermediate buffer is to be used;
enabling reading of a subset of the incoming data directly into the application buffer associated with an application when a first set of criteria is met; and
enabling reading of existing data from the intermediate buffer and storing the subset of the incoming data in the intermediate buffer when a second set of criteria is met.

2. The method of claim 1, further comprising notifying a first peer connection associated with the first peer computer when the incoming data arrives at the first peer computer.

3. The method of claim 1, wherein the first set of criteria includes that the intermediate buffer is empty.

4. The method of claim 1, wherein the second set of criteria includes at least one of a group consisting of:
data is found in the intermediate buffer; and
the application has not provided information associated with the intermediate buffer.

5. The method of claim 1, wherein enabling reading of the subset of the incoming data directly into the application buffer further comprising communicating with a channel connection associated with the application at the first peer computer to obtain memory location information of the application buffer.

6. The method of claim 5, further comprising passing the memory location information to a first peer connection associated with the first peer computer, wherein the first peer connection is used for connecting with the second peer computer.

7. The method of claim 1, further comprising enabling multithreaded access to the intermediate buffer.

8. The method of claim 1, wherein the intermediate buffer is a circular buffer associated with a channel connection for the application.

9. The method of claim 1, further comprising providing the first peer connection direct access to a respective application buffer that has outgoing data to access the outgoing data for transport from the first peer computer.

10. The method of claim 1, further comprising, when a decision is made to store the subset of the incoming data in the intermediate buffer, storing the subset of the incoming data in the intermediate buffer in a sequence that the subset of the incoming data is received.

11. A system for peer computer-to-peer computer communication, the system comprising:
at least one peer connection at a first peer computer of a plurality of peer computers, the at least one peer connection is in connection with a second peer computer when the first peer computer and second peer computer are in communication;
a plurality of application buffers associated with corresponding applications at the first peer computer;
a plurality of channel connections associated with corresponding applications at the first peer computer, the respective channel connection for determining if a first set criteria or a second set of criteria is satisfied and for enabling a respective subset of incoming data from a second peer computer to be read directly into a respective application buffer of the plurality of application buffers when the first set of criteria is satisfied; and
a plurality of intermediate buffers corresponding to the applications, wherein the channel connection enables the subset of the incoming data to be stored in a respective intermediate buffer when the second set of criteria is satisfied.

12. The system of claim 11, further comprising a read interface associated with a respective channel connection.
